(19) United States
(12) Patent Application Publication
(10) Pub. No.: US 2005/0285702 A1
(43) Pub. Date: Dec. 29, 2005

(54) UNIVERSAL WAVEGUIDE INTERFACE ADAPTOR

(75) Inventors: Frank J. Graczyk, New Lenox, IL (US); James Giacobazzi, Bloomingdale, IL (US)

Correspondence Address: BABCOCK IP LLC, 24154 LAKESIDE DRIVE, LAKE ZURICH, IL, 60047, US

(73) Assignee: ANDREW CORPORATION, Orland Park, IL (US)

(21) Appl. No.: 10/710,205

(22) Filed: Jun. 25, 2004

(51) Int. Cl. H01P 1/04

(52) U.S. Cl. 333/254

(57) ABSTRACT

A waveguide adaptor assembly with interface and waveguide ends for coupling an end of a waveguide with a desired interface configuration. The assembly including a flange adaptor adapted to receive the end of the waveguide. An outer shoulder projecting radially from the interface end of the flange adaptor is adapted to mate with a recessed area formed in the waveguide end of an interface. A pair of retaining groove(s) on opposing sides of the recessed area co-operating with each other and adapted to receive a retainer that, pressing upon a waveguide end of the outer shoulder as it is inserted, biases the interface end of the flange adaptor against the recessed area. The interface having the desired interface configuration at the interface end.

### BACKGROUND OF INVENTION

1. Field of the Invention

This invention relates to waveguides and adaptations of waveguides to various interface components and more particularly to a method and apparatus for coupling a waveguide to any of a range of desired interfaces, for example a flange.

2. Description of Related Art

Waveguides are commonly used for transmitting electromagnetic wave energy from one point to another. Waveguides are useful for the transmission of electromagnetic signals between, for example, antennas and transmitting or receiving equipment. Typically, the waveguide consists of a hollow metallic tube of defined cross-section, uniform in extent in the direction of propagation. Within the hollow tube, the electric and magnetic fields are confined. Waveguides may be either of a rigid wall or flexible variety and their cross-sectional shapes may be, for example, rectangular, circular, or elliptical.

Waveguides are typically coupled to transmitting or receiving equipment at some point. Both the design of the waveguide, as well as coupling systems for use therewith, are critical to the efficiency of the overall system. In order to reduce reflection losses and impedance mismatches, waveguides are securely mounted via an interface such as a waveguide flange connector. Interface and coupling assemblies have been designed and implemented for connecting waveguides to each other as well as to receiving or transmitting equipment. Problems may occur at junctions between the waveguide and the selected interface(s), between the two mating interface surfaces of coupled waveguides and or between a waveguide and equipment connected thereto. Possible issues that may be encountered include reflected power, high VSWR, power leakage and arcing.

Specifications for standard interfaces, such as waveguide mounting flanges, vary from one application to another. The waveguides themselves are typically of standard dimensions, while an interface for coupling a standard waveguide to one manufacturer's equipment may not be adapted for coupling to the interface of another manufacturer's equipment. For that reason, waveguide sections have been produced with a variety of interfaces, typically permanently secured on the ends thereof.

One method of mounting a waveguide to an interface incorporates the use of molten solder. Solder creates an electrically uniform and secure connection. However, for quality control purposes solder connections are typically applied in a factory rather than in a field environment. Therefore, waveguides are commonly sold with the desired interface pre-installed.

Manufacturers and suppliers of equipment, such as waveguides and interfaces for the telecommunication industry, attempt to fill orders with the shortest possible delay between order reception and order delivery. Thus parts are typically maintained in stock for particular applications even if they have a low turnover. Further, if a unique assembly is ordered but returned, it must be held in inventory until a similar order is placed again, if ever. It is an advantage therefore to provide a waveguide and interface adaptor that is designed for multiple applications, whereby the level of inventory dedicated to unique configurations can be reduced and returned units disassembled into generic assemblies for re-sale.

Flange adaptors for the mounting of a waveguide interface coupled to at least one end of a waveguide reduce the inventory requirements for waveguide assemblies by allowing pre-manufacture and inventory of a common assembly quickly adaptable to a specific desired interface configuration. Pub. No. U.S. 2003/0137465 of U.S. patent application Ser. No. 10/056,679 filed Jan. 24, 2002 by Graczyk et al., assigned to Andrew Corporation of Orland Park, Ill., as is the present invention, describes a flange adaptor assembly usable with a wide range of interfaces. Pub. No. U.S. 2003/0137465 relies upon a significant plurality of fasteners such as bolt into threaded bolt-hole connections to achieve the desired structural integrity of the flange adaptor to interface connection. To provide an even connection force across the face of the flange adaptor, care is required whereby each fastener connection is installed with a similar level of torque. Also, the plurality of fasteners and extra machining operations related to the fasteners themselves, the flange adaptor and the family of desired interface(s) creates a significant manufacturing, parts co-ordination and installation expense that reduces the inventory reduction savings resulting from its use.

Therefore, it is an object of the invention to provide an apparatus that overcomes deficiencies in the prior art.

### BRIEF DESCRIPTION OF DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is an exploded, perspective view of a waveguide and interface assembly according to an exemplary embodiment of the invention.

FIG. 2A is an enlarged, perspective view of the waveguide end of a flange adaptor for a waveguide with an outer sheath, as shown in FIG. 1.

FIG. 2B is an enlarged, perspective view of the waveguide end of a flange adaptor for a waveguide without an outer sheath.

FIG. 3A is an enlarged, perspective view of the interface end a flange adaptor for a waveguide with an outer sheath, as shown in FIG. 1.

FIG. 3B is an enlarged, perspective view of the interface end of a flange adaptor for a waveguide without an outer sheath.

FIG. 4A is an enlarged, perspective view of the waveguide end of a rectangular flange interface as shown in FIG. 1.

FIG. 4B is an enlarged, perspective view of the waveguide end of an alternative interface, a circular flange, with an extended waveguide portion.

FIG. 5 is an enlarged, perspective view of a retainer as shown in FIG. 1.

FIG. 6 is an enlarged, perspective view of the interface end of a rectangular flange interface as shown in FIG. 1.

### DETAILED DESCRIPTION

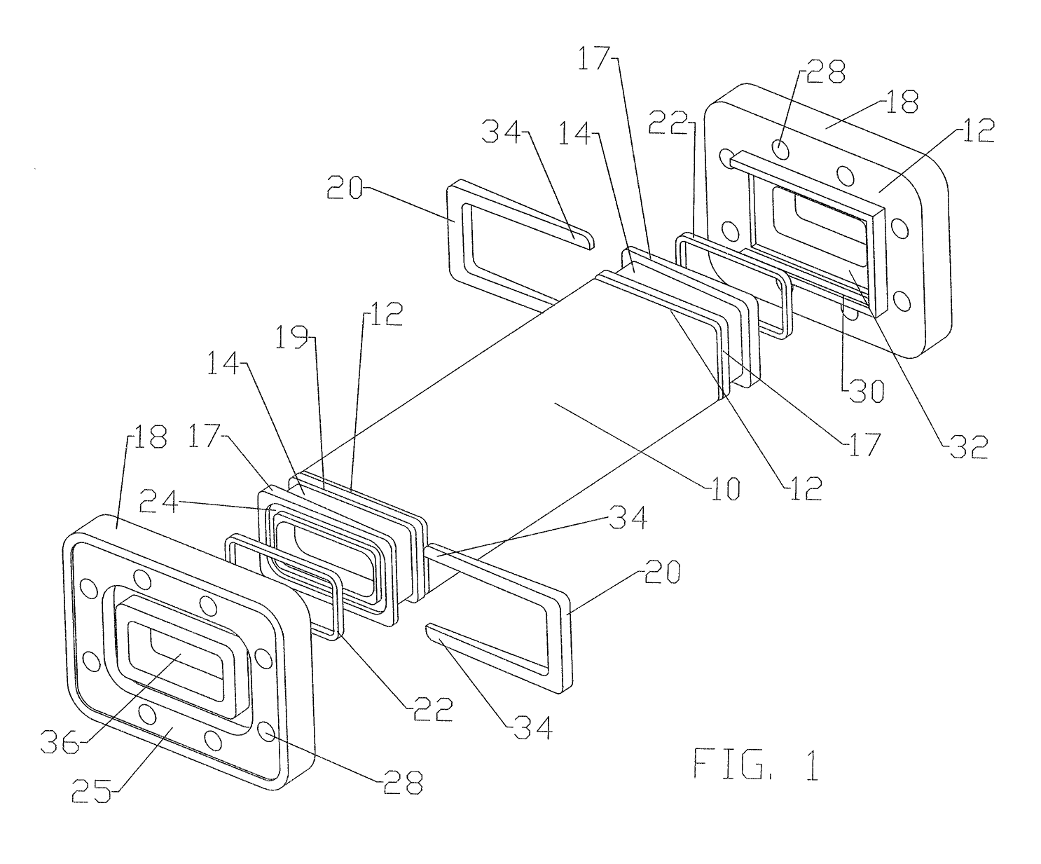

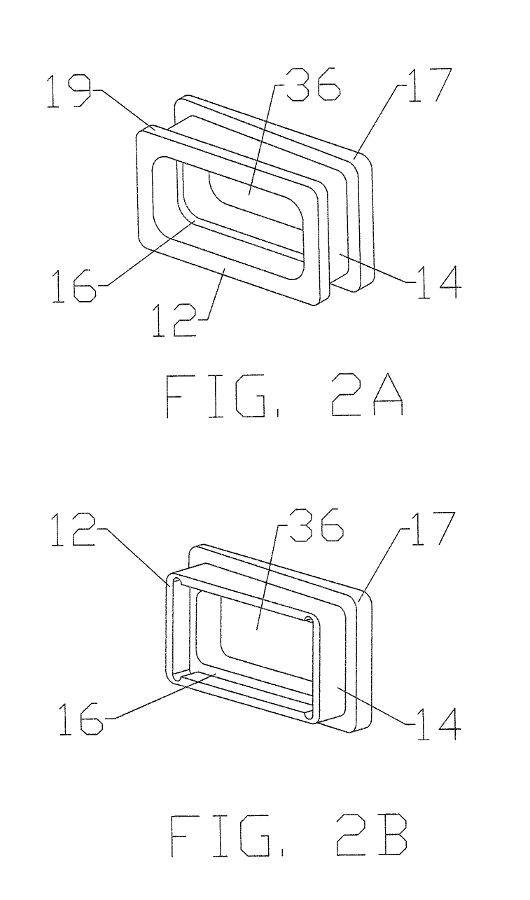

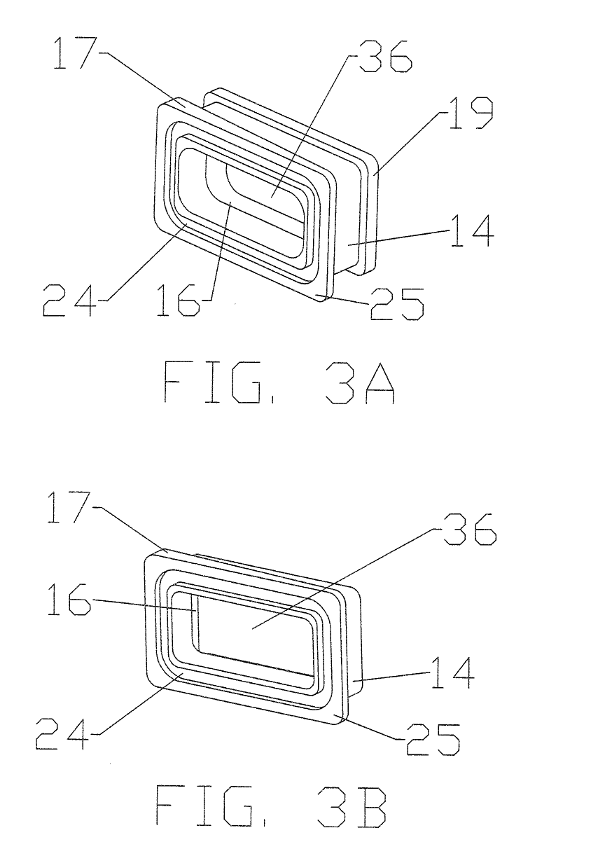

As shown in FIG. 1, each end of the waveguide 10 may be connected to the waveguide end 12 of a flange adaptor 14. At the waveguide end 12 of the flange adaptor 14, as shown in FIGS. 2A and 2B, a means for connection such as an inner shoulder 16 operates as a mounting region to receive the outer edges and surfaces of an end of the waveguide 10. A width of the inner shoulder 16 is adapted to the expected waveguide 10 wall thickness so that when the waveguide 10 end is seated in the inner shoulder 16 a flush interconnection is formed between a central passage of the waveguide 10 and a central passage 36 of the flange adaptor 14 that has the same cross-sectional dimension as the waveguide 10. As shown in FIGS. 1, 2A and 3A, the flange adaptor 14 may also have a sheath shoulder 19 for use with a flexible waveguide 10, or any other type of waveguide 10 with an outer sheath. The width of the sheath shoulder 19 is adapted to the expected thickness of the sheath and thus smoothes the external transition from the flange adaptor 14 to the waveguide 10. When a waveguide 10 that is rigid, or any other waveguide 10 without an outer sheath is used, flange adaptors 14 without sheath shoulders 19, as shown in FIGS. 2B and 3B, may be applied.

A gasket 22 may be seated in a recessed channel 24 formed in the interface end 25 of the flange adaptor 14, as shown for example in FIGS. 3A and 3B, to environmentally seal the interconnection between the flange adaptor 14 and the interface 18. Alternatively, the recessed channel 24 may be formed in a recessed area 32 of the interface 18. The gasket 22 may be, for example, silicon, EPDM, nitril, or the like according to the expected environmental conditions and or cost considerations.

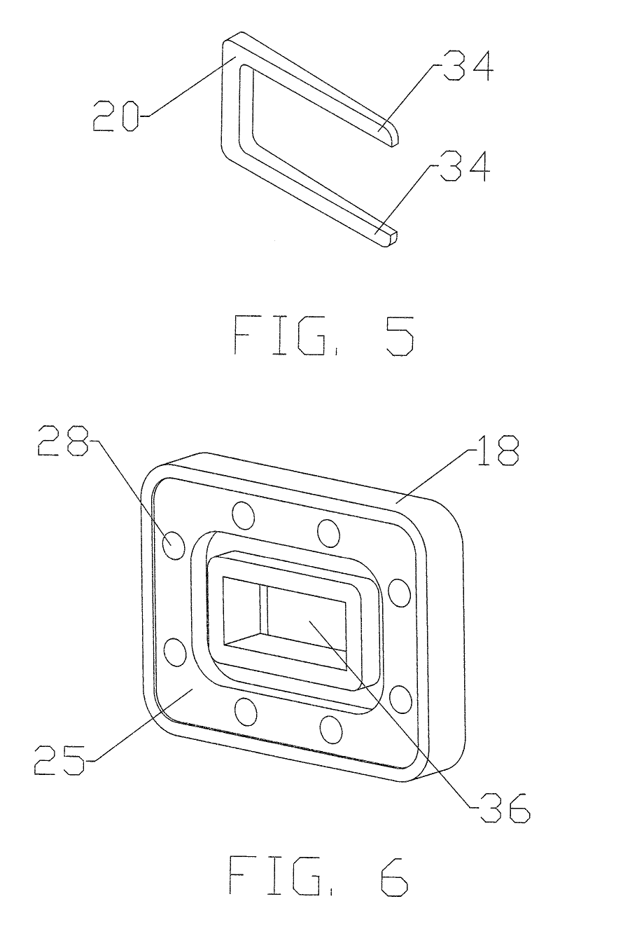

A retainer 20 retains a desired interface 18 upon the flange adaptor 14 in cooperation with a retaining groove 30 and a recessed area 32 on the waveguide end 12 of the interface 18. The retainer 20, as shown for example in FIG. 5, may have a C-shaped configuration. Alternatively, the retainer 20 may comprise a plurality of individual pins, wedges, keys, tabs or the like. Leading edges 34 of the retainer 20 are preferably tapered. The selected angle of the taper mating with a corresponding angle of the waveguide end 12 of the outer shoulder 17 of the flange adaptor 14 as described herein below.

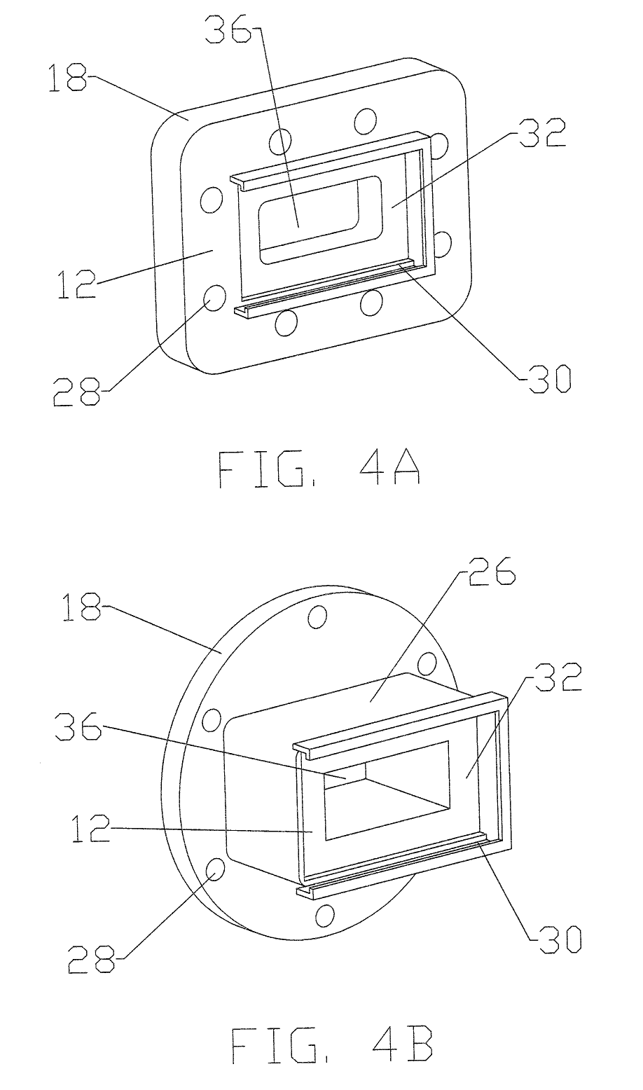

As shown for example in FIGS. 4A and 4B, the interface 18 may be any desired flange, mounting, or other mounting adaptor adapted on the waveguide end 12 to couple with the interface end 25 of the flange adaptor 14. The recessed area 32 is formed to receive the interface end 25 of the flange adaptor 14. Precision alignment of the interface 18 to the flange adaptor 14 in tangential directions with respect to a longitudinal axis of the waveguide 10 is a function of the machining tolerances applied to the fit between the recessed area 32 and the interface end 25 of the flange adaptor 14. The retaining groove(s) 30 are formed, for example, with sections facing each other on opposing sides of the recessed area 32. Alternatively, the retaining groove(s) 30 may be formed as a plurality of tabs under which the retainer is retained.

Alternatively, the interface 18 may also be formed with an extended waveguide portion 26, as shown for example in FIG. 4B, to facilitate the unhindered access to fasteners (not shown) applied to the apertures 28 related to the connection of the selected interface 18 to further waveguide(s) 10 and or other equipment as well as removal of the retainer 20 without disturbing any of these fasteners that may otherwise be located in an interference position with respect to movement of the retainer 20 along the retaining groove 30 as described herein below. The interface end 25 of the interface 18, for example as shown in FIG. 6, may be any configuration as required to mate with a desired flange or other interface.

When inserted along the retaining groove(s) 30 against the outer shoulder 17 of a flange adaptor 14 with the interface end 25 inserted into the recessed area 32, the retainer 20 operates to bias the interface end 25 of the flange adaptor 14 upon the recessed area 32. Preferably, an angled face on the waveguide end 12 of the outer shoulder 17 of the flange adaptor 14 mates with a corresponding inversely angled face of the retainer 20 whereby a uniform force in a direction parallel to the longitudinal axis of the waveguide 12 is applied across the interface end 25 of the flange adaptor 14, against the recessed area 32 securely seating the flange adaptor 14 against the recessed area 32. Interconnected, the flange adaptor 14 and interface 18 form a coaxial central passage 36 with minimal discontinuity between the waveguide 10 and a final interface interconnection.

In use, the flange adaptor 14 may be pre-attached to the selected waveguide 10 with a solder, conductive adhesive connection or friction fit at the means for connection. Completed waveguide 10 and flange adaptor 14 assemblies may be prepared and placed in inventory. When an order is filled each selected interface 18 is mated with the flange adaptor 14 and the retainer 20 installed into the retaining groove 32 and against the angled surface of the outer shoulder 17 in a friction fit, for example with the aid of a hydraulic press to form a semi-permanent interface 18 to waveguide 10 connection.

From the foregoing, one skilled in the art will appreciate that the invention provides a flange adaptor usable with a wide range of interfaces, whereby prior requirements for interface specific inventory are eliminated. Further, the complexity of and time requirements for final assembly operations are reduced, relative to prior solutions relying upon installation of multiple fasteners to achieve structural integrity of the flange adaptor to interface connection.

Table of Parts

| | |
|---|---|
| 10 | waveguide |
| 12 | waveguide end |
| 14 | flange adaptor |
| 16 | inner shoulder |
| 17 | outer shoulder |
| 18 | interface |
| 19 | sheath shoulder |
| 20 | retainer |
| 22 | gasket |
| 24 | recessed channel |
| 25 | interface end |
| 26 | extended waveguide portion |
| 28 | apertures |
| 30 | retaining groove |
| 32 | recessed area |
| 34 | leading edges |
| 36 | central passage |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A waveguide adaptor assembly with interface and waveguide ends for coupling an end of a waveguide with a desired interface configuration, comprising:
an outer shoulder projecting radially from the interface end of the flange adaptor;
an interface with a recessed area formed in the waveguide end adapted to receive the interface end of the flange adaptor;
the interface having the desired interface configuration at the interface end;
a pair of retaining groove(s) on opposing sides of the recessed area facing each other; and
a retainer adapted to insert along the retaining groove(s) and against the waveguide end of the outer shoulder, biasing the interface end of the flange adaptor against the recessed area.

2. The assembly of claim 1, wherein the waveguide end of the flange adaptor has an inner shoulder projecting radially inward about a central passage.

3. The assembly of claim 2, wherein the inner shoulder has a width corresponding to a sidewall thickness of the waveguide whereby a central passage of the flange adaptor is flush with an inner surface of the waveguide upon insertion of the end of the waveguide into the inner shoulder.

4. The assembly of claim 1, wherein the waveguide end of the outer shoulder and a leading edge of the retainer are inversely angled with respect to a longitudinal axis of the waveguide.

5. The assembly of claim 1, further including a recessed channel formed in the interface end of the flange adaptor; and
a gasket adapted to seat into the recessed channel.

6. The assembly of claim 1, wherein a recessed channel is formed on the waveguide end of the interface; and
a gasket adapted to seat into the recessed channel.

7. The assembly of claim 1, wherein the interface has an extended waveguide portion between the interface end and the waveguide end.

8. The assembly of claim 1, wherein the retainer is c-shaped.

9. The assembly of claim 1, wherein the retainer is a snap ring.

10. The assembly of claim 1, wherein the retaining groove(s) are tangential to a longitudinal axis of the waveguide.

11. The assembly of claim 1, wherein the retainer is removable.

12. The assembly of claim 1, wherein the flange adaptor has a sheath shoulder projecting radially outward from the waveguide end.

13. A method for forming a waveguide adaptor assembly with interface and waveguide ends for coupling an end of a waveguide with a desired interface configuration, comprising the steps of:
abutting an end of the waveguide with an inner shoulder located on the waveguide end of a flange adaptor;
abutting the interface end of the flange adaptor with a recessed area located on the waveguide end of an interface; and
inserting a retainer along at least one retaining groove(s) and against the waveguide end of the outer shoulder, biasing the interface end of the flange adaptor against the recessed area.

14. The method of claim 13, wherein the retainer is inserted orthogonally with respect to the longitudinal axis of the waveguide.

15. The method of claim 13, wherein the retainer is inserted using a hydraulic press.

16. The method of claim 13, wherein the insertion of the retainer forms a friction fit.

17. The method of claim 13, wherein the retainer is adapted to be removable after insertion.

18. The method of claim 13, further including the step of:
positioning a gasket into a recessed channel located on the interface end of the flange adaptor.

19. The method of claim 13, further including the step of:
positioning a gasket into a recessed channel formed in the recessed area.

20. A waveguide adaptor assembly, comprising:
a waveguide having a central passage, a first end and a second end;
a flange adaptor coupled to each of the first end and the second end via an inner shoulder formed projecting radially inward at a waveguide end of the flange adaptor(s);
the inner shoulder adapted to receive the waveguide; and
the flange adaptor(s) having an outer shoulder projecting radially from an interface end of the flange adaptor.

21. The assembly of claim 20, wherein a waveguide end of the outer shoulder has an angled face.

22. A waveguide adaptor assembly with interface and waveguide ends for coupling an end of a waveguide with a desired interface configuration, comprising:
a flange adaptor with an inner shoulder formed in the waveguide end adapted to receive the end of the waveguide;
an outer shoulder projecting radially from the interface end of the flange adaptor;
an interface with a recessed area formed in the waveguide end adapted to receive the interface end of the flange adaptor;
a pair of retaining groove(s) on opposing sides of the recessed area facing each other; and
a c-shaped retainer adapted to insert along the retaining groove(s) and against the waveguide end of the outer shoulder, biasing the interface end of the flange adaptor against the recessed area;
the waveguide side of the outer shoulder and a leading edge of the c-shaped retainer inversely angled with respect to a longitudinal axis of the waveguide;
the interface having the desired interface configuration at the interface end.
